(19) United States
(12) Patent Application Publication
(10) Pub. No.: US 2009/0211106 A1
(43) Pub. Date: Aug. 27, 2009

(54) Treatment of Drill Cuttings

(76) Inventor: Martin McKenzie, Aberdeenshire (GB)

Correspondence Address: Thomas M. Galgano, 20 W. Park Avenue, Suite 204, Long Beach, NY, 11561, US

(21) Appl. No.: 11/922,521

(22) PCT Filed: Jun. 19, 2006
(86) PCT No.: PCT/GB2006/002238

§ 371 Date: Apr. 2, 2009

(30) Foreign Application Priority Data
Jun. 20, 2005 (GB) 0512485.4

(51) Int. Cl. F26B 13/30

(52) U.S. Cl. 34/92

(57) ABSTRACT

An apparatus is disclosed for decontaminating cuttings produced from. a wellbore. The cuttings (11) are conveyed on a belt (13), made of a mesh material, to a decontamination region where, under reduced pressure and elevated temperature organic materials are removed, together with a quantity of water. In order to facilitate the process, a depth gate (14) is provided to control the depth of the cuttings (11) on the belt (13). The organic materials can be either collected and reused or alternatively burnt off. Once the cuttings (11) have been decontaminated they can be safely discharged or reused as part of the drilling process.

To facilitate the process means (112,113) can be included which clean the belt (13) and remove compacted regions to prevent the mesh from becoming clogged up. A heat exchanger (18) can also be included to reclaim thermal energy used in the decontamination region

The present invention. relates to apparatus and methods suitable for processing drill cuttings to reduce the level of their contamination. The apparatus and method are particularly suitable for use off-shore, such as on an oil rig.

When carrying out drilling in oil or gas wells, large volumes of waste material are produced known commonly as drill cuttings, The drill cuttings are primarily clay or rock of the surrounding strata and are usually contaminated with organic materials, principally aliphatic and aromatic hydrocarbons, which arise either as lubricants used in the drilling process or from the oil or gas reservoirs.

Because of the contamination, the drill cuttings cannot be disposed of easily, as legislation prohibits the dumping overboard, from an off-shore rig, of cuttings having an organic phase greater than 1% w/w.

In order to overcome this difficulty, the most commonly used method is to collect the cuttings and transport them to an on-shore processing facility in which the organic material is removed prior to disposal of the decontaminated cuttings in a conventional land fill site. Such a method is however expensive, due partly to the transport cost, and also places a burden on local land fill sites.

WO03/104607 discloses a method in which a motive fluid is used to scrub drill cuttings through friction. This method can be used both on-shore and off-shore.

It is an object of the current invention to address the above problems and provide an improved apparatus and method for treating drill cuttings.

### SUMMARY OF THE INVENTION

According to a first aspect of the invention there is provided an apparatus for the decontamination of organic contaminants from drill cuttings, the apparatus including:
a conveying means comprising an endless belt of mesh material to carry cuttings through a decontamination region;
a means to reduce the pressure around the cuttings and to draw air through the cuttings and the mesh, said air being heated by a heater prior to the air passing through the cuttings thereby removing a proportion of the organic contaminants and water; a depth gate to control the depth of drill cuttings on the belt.

The apparatus reduces the level of contaminants in a rapid and efficient manner.

Advantageously, the organic contaminants and water are collected in the condenser. The organics materials can thereby be reused or disposed of safely. Alternatively, the apparatus can include a burner to directly burn organic contaminants.

Preferably, the apparatus includes a second endless mesh belt to receive the cuttings prior to their entering the decontamination region. The second belt enables an initial pre-treatment to be carried out.

The second belt is optionally in the form of a cylinder, rotatable about the main axis of the cylinder. A means to reduce the pressure and draw air through the cuttings and the second belt is advantageously included. The depth of the cuttings on the second belt is controlled by a second depth gate.

The mesh size of the first and second belts is preferably greater than 5μ. Advantageously, the mesh size of the second belt is smaller than that of the first belt. The greater mesh size allows the provision, more economically, of a robust belt.

An air flow sensor is advantageously included to determine the air flow across one or both of the belts. The air flow sensor is particularly advantageously coupled by means of a control unit, to the belt speed and the bed depth gate.

A pressure sensor is preferably included to determine the pressure to which the cuttings are being subjected. The pressure sensor is advantageously coupled, by means of a control unit, to the belt speed and the bed depth gate.

Advantageously, the temperature is maintained at 120-140C.

The reduced pressure to which the cuttings are subjected is preferably from 18-35 (38-89 cm) inches of water.

The apparatus optionally includes a heat exchanger intermediate the cuttings and a condenser to remove excess heat from the contaminant-laden air stream.

The apparatus preferably includes cleaning means to clean the or each belt. The cleaning means is optionally selected from one or more of a brush having a rotating or linear brushing action or a gas jet. The mesh of the belt is therefore kept clear and the flow of air facilitated. Further optionally, where two or more cleaning means are used, at least two of these are on opposite sides of the belt.

Preferably, a gas jet is included to agitate the drill cuttings on the belt, thereby allowing a greater proportion of cuttings surfaced to be exposed and hinder the build up of compacted regions on the belt.

### BRIEF DESCRIPTION OF THE DRAWINGS

The invention will now be described with reference to the accompanying drawings which show, by way of example only, three embodiments of drill cutting treatment apparatus. In the drawings:

FIG. 1 is a diagram of a first embodiment of apparatus;

FIG. 2 is a diagram of a second embodiment of apparatus; and

FIG. 3 is a diagram of a third embodiment of apparatus.

### DETAILED DESCRIPTION OF THE DRAWINGS

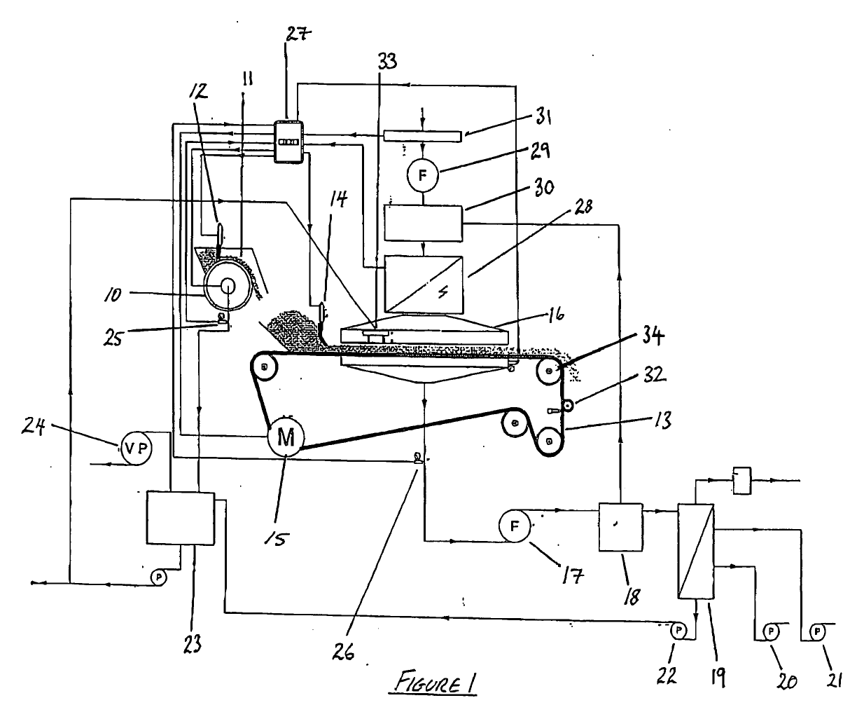

In FIG. 1, a first embodiment of apparatus for use in the treatment of drill cuttings is shown. In summary, the apparatus provides for hot air to be passed across a layer of the drill cuttings material to be treated. The hot air causes evaporation of volatile organic components and water from the material, which contaminants and water are subsequently removed from the hot air stream by means of a condenser unit. The decontaminated drill cuttings, as they are now within legal requirements, can then be disposed of by, for example, dumping at sea. The organic compounds collected in the condenser can either be utilized further by adding to a drill bore to assist the drilling process or disposed of through conventional methods.

In more detail, the drill cuttings are delivered to an initial vacuum unit, the unit being in the form of a rotatably mounted drum 10. At this point the drill cuttings can include up to 20% w/w of organic hydrocarbons. Typically the cuttings are conveyed to the apparatus from shale shakers by conventional means. Such means can be mechanical, as in the case of augers or tube chain conveyers. Alternatively, vacuum or positive pressure methods can be employed.

The drum 10 enables an initial air flow to be established through the cuttings and comprises a fine mesh screen in the form of a cylinder, the cylinder being rotatably mounted about its central axis. A vacuum is provided to draw air through the cuttings and the screen into the internal volume of the drum 10. In order to control the thickness of the layer of cuttings 11 on the screen, a depth gate 12 is provided which controls the flow of cuttings from the feed.

The initial treatment performs a dual function. Firstly, it enables the height at which to set the second depth gate, described below, to be determined. Secondly, fine mud, which has a relatively high proportion of organic hydrocarbons can pass through the screen and be carried to the mud receiver 23. Following the initial treatment, the level of organics is often reduced to around 4-5% w/w.

From the drum 10, the cuttings pass on to an endless porous woven mesh belt 13. Such belts are well known in the industry and frequently comprise a mesh, often up to 1 cm in thickness, formed of 3 mm steel wire. Again, the depth of the layer of cuttings is controlled here by means of a second depth gate 14. The belt 13 whose motion is driven by a motor 15 delivers the cuttings into an evaporation region beneath an air distribution duct 16. To prevent the belt 13 sagging, particularly under the combined mass of the cuttings, the air flow conditions and the pressure differential, the belt 13 is supported on steel guides (not illustrated).

In the evaporation region, the cuttings are subjected to low pressure and to the flow of hot air drawn by a vacuum fan 17. The fan is capable of delivering 400 Cfm of air on the belt. The air is at a temperature and pressure sufficient to flash off the majority of the volatile organic compounds from the cuttings 11 as well as a large amount of the water. This process is assisted by the fact that normally the majority of organics lie on or close to the surface of cuttings particles and not in the particles' internal volumes.

From the vacuum fan 17 the air, together with the organics and water, pass firstly to a heat recovery unit 18 and thence to a condenser 19. In the condenser 19, the different components drawn off the cuttings 11 are separated into the various fractions. Water passes through a water discharge pump 20 and the organics through an oil discharge pump 21. It will be recognized that where a large number of factions of differing boiling points are to be collected then further condensers/pumps can be included.

As an alternative, the organics can be passed through a burner (not illustrated) to convert them into harmless carbon dioxide and water.

Any mud particles from the cuttings which pass into the condenser 19 are collected at the bottom of the condenser 19 and pumped out via a sludge discharge pump 22 to a mud receiver 23. If necessary, the flow into the receiver 23 can be assisted by the use of a vacuum pump 24. The mud receiver 23 also receives fines from the initial material which passes through the drum 10 and which normally has a high organic content. Collected mud from the receiver 23 can periodically be discharged and can be reused on a drill rig. Alternatively, the mud can be reinjected onto the endless belt 13 through the mud reinjection nozzle 33. At this stage, material on the endless belt 13 is in the form of a caked material and therefore prevents the fine mud from passing through the belt.

The depth of the layer of cuttings on the drum 10 and on the belt 13 is governed by the ability of the layer to allow air to pass through. Air flow is determined by air flow sensors 25, 26 which relate to the drum 10 and the belt 13 respectively. The air flow sensors 25, 26 pass the measurement to a PLC control panel 27 which oversees the functioning of the apparatus. A suitable air flow has been found to be around 14 ls⁻¹, although this value can be selected and adjusted by the operator, depending upon the particular cuttings being treated. Once the value has been set the PLC control panel 27 adjusts the heights of the depth gates 12, 14 to increase or restrict the flow of cuttings onto the drum 10 or belt 13. The greater the cuttings' depths the lower will be the air flow. The PLC control panel 27 also determines the speed of the drum 10 or belt 13, which speed also governs the air flow.

It has been found that a good degree of control can therefore be exerted over the air flow by adjustment, either alone or in combination, of the gate height and the belt speed. The prime parameter governing air flow volume is the particle size of the drill cuttings. In general, the smaller the average particle size of the cuttings, the thinner the layer of cuttings will be which can be tolerated. In order to provide the heated air to rapidly heat the cuttings to the desired temperature, a heater pack 28 is included which can heat air drawn in by an intake fan 29: typically to a temperature around 130 C. The air is then forced by the fan 29, operating in combination with the vacuum fan 17 via the duct 16, through the cuttings. In this section of the apparatus it has been found that a value for the vacuum of from 18-35″ (38-89 cm) of water is effective and typically a value of 28″ (71 cm) of water is used.

In order to assist the heating process, it has been found advantageous to include an air pre-heater 30. In the embodiment shown in FIG. 1, heat from the heat recovery unit is used to supplement heat provided in the air pre-heater 30. To reduce the chance of and limit the damage of any vapor phase explosions within either the air pre-heater 30 or the heater pack 28 a fire damper 31 is included. The fire damper 31 includes a gas detector to detect unwanted organics.

On leaving the apparatus the cuttings, which are now in a dry and free flowing condition are loosened from the belt 13 as the belt 13 passes over the roller 34.

Using the above apparatus, the combination of hot air flowing together with the applied vacuum means that the majority of organics are removed and levels of <1% w/w, can be achieved with one pass through the apparatus.

### Experiment 1

A sample of pre-treated drill cuttings was passed through the second portion of the apparatus described in FIG. 1 material being added to the second belt 13, Following pre-treatment, the cuttings had initially an aliphatic hydrocarbon content of around 4028 mg/kg and an aromatic hydrocarbon content of 307 mg/kg, giving a total hydrocarbon content of 4335 mg/kg.

The temperature of the heated air was set at 130 C, and the vacuum at 25 inches (64 cm) of water, with an air speed of 12-14 ms⁻¹. In an initial sample of 2 kg of the above pre-treated cuttings, the total hydrocarbon content was reduced to 0.43% w/w after passage through the evaporation region. When scaled up this would equate to approximately 2 tonne of treated material per square metre of belt per hour.

Although a vibration or plough mechanism can be employed to agitate the layer of cuttings and so increase air flow around each particle, care should be taken that such mechanisms do not break up the particles themselves. Breakage of the particles would not cause malfunctioning of the apparatus, bat nevertheless would increase the energy consumption or the time required to bring the organics level down to an acceptable value. As indicated above, the interior volume of cutting particles does not tend to include organics. To break the particle therefore increases the surface area of the particles without increasing accessibility to organics of the heat, which is therefore inefficient.

The cuttings passing off the belt 13 are periodically analyzed to determine the remaining organic content. Such analysis can be carried out by conventional means such as FTIR or GCMS. If necessary, these can be passed into the apparatus for further treatment. In order to maintain the belt 13 in a usable condition a belt cleaning brush 32 is included: the brush 32 being of conventional type.

It has been found that it is advantageous for the mesh size for the drum filter and belt filter to be different, with a size of around 50 for the drum filter being suitable. In general, although the mesh sizes of the two belts can be substantially similar, that of the second belt will generally be greater than that of the drum Filter or of the pre-treatment belts described in the embodiments described below.

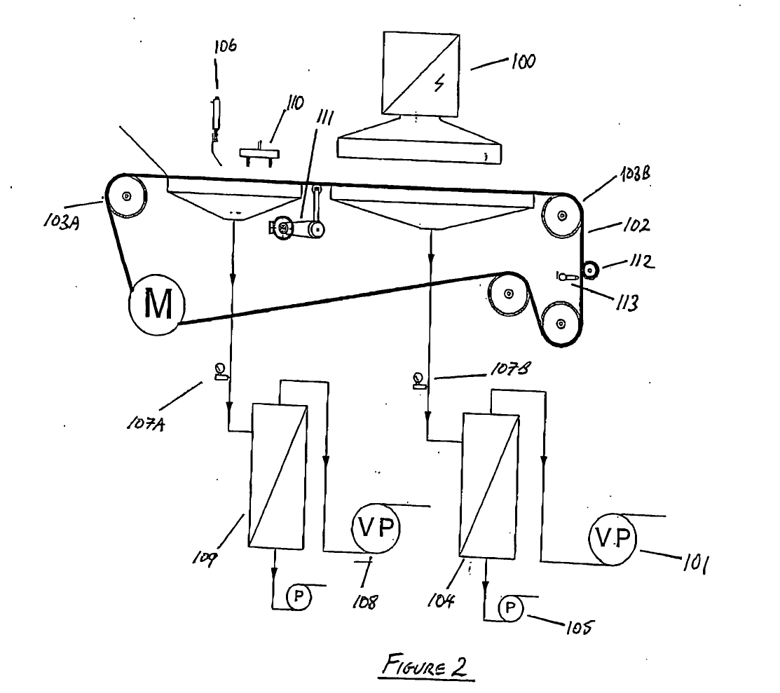

FIG. 2 shows a second embodiment of an apparatus for treating drill cuttings which requires only a single conveying belt. In common with the first embodiment shown above, the apparatus includes an evaporation region in which hot air from a heater 100 is drawn through a layer of drill cuttings by means of a vacuum pump 101. The cuttings are carried through the region on an endless belt 102 kept in motion by support rollers 103A, 103B. Once the volatiles and any water has been removed from the cuttings they are condensed out in a condenser 104 and eventually discharged through the pump 105.

The cuttings are delivered to the apparatus onto the endless belt 102 by a feed hopper. In order to control the thickness of the layer of cuttings on the belt, the bed depth gate 106 can be raised or lowered under the control of a PLC control panel (not illustrated). As with the previous embodiment, the bed depth layer is determined by the vacuum sensors 107A, 107B which feed information to the PLC control panel.

In order to remove an initial portion of organics the cuttings are subjected to a partial vacuum from beneath the belt. The vacuum is provided by a second vacuum pump 108, operatively connected in series with a second condenser 109 to the delivery region of the apparatus. A collection duct ensures that vapor from the cuttings is directed to the condenser. In order to assist the evaporation process, a compressed gas wash nozzle 110 is located above the delivery region to deliver a jet or jets of gas to the cuttings. The jet of gas serves firstly to agitate the layer of cuttings to prevent compaction and also to entrain the vapor from the cuttings. In addition, the jet hinders the mesh of the conveyer belt 102 from becoming clogged up with material.

The process of agitation of the belt 102 and the cuttings is further improved through the use of a belt vibrator 111. Once the cuttings have been removed from the belt 102 following treatment, the belt 102 is cleaned by a combination of the use of a rotating brush 112 and a compressed gas wash nozzle 113 acting on opposite sides of the belt.

In this embodiment, care must be taken in selection of the material from which the belt is made to ensure that it can provide efficient removal of fines, without undergoing damaging distortion, primarily due to the action of heat, in the evaporation region.

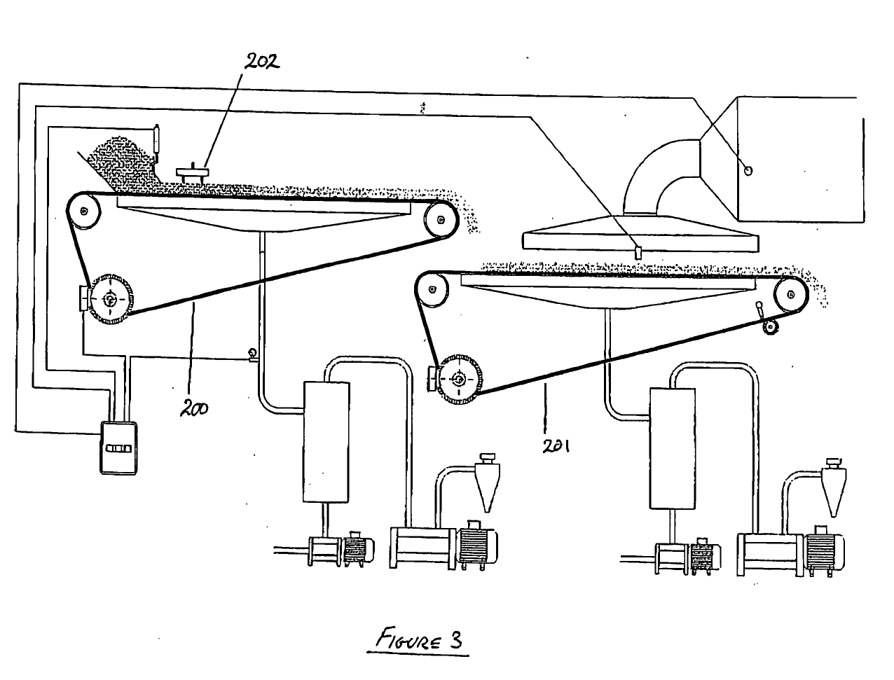

The third embodiment shown in FIG. 3 operates in principal in a similar fashion to the first two embodiments. The prime difference is the provision of two endless belts 200, 201 on which cuttings are conveyed. Treatment again takes place in two stages, the first stage in this embodiment occurring as material is transported on a first endless belt 200 on which agitation of the cuttings takes place by means of a compressed gas jet emitted from the nozzle 202.

It will of course be understood that the invention is not limited to the specific details described herein, which are given by way of example only, and that various modifications and alterations are possible with the scope of the appended claims.

1. An apparatus for the decontamination of organic contaminants from drill cuttings the apparatus comprising:
a conveying means comprising an endless belt of mesh material to carry cuttings through a decontamination region;
a means to reduce the pressure around the cuttings and to draw air through the cuttings and the mesh, said air being heated by a heater prior to the air passing through the cuttings thereby removing a proportion of the organic contaminants and water;
a depth gate to control the depth of drill cuttings on the belt.

2. An apparatus according to claim 1, wherein the organic contaminants and water are collected in a condenser.

3. An apparatus according to claim 1, wherein the apparatus includes a burner to burn directly organic contaminants.

4. An apparatus according to claim 1, wherein the apparatus includes a second endless mesh belt to receive the cuttings prior to their entering the decontamination region.

5. An apparatus according to claim 4, wherein the apparatus includes means to reduce the pressure and draw air through the cuttings and the second belt.

6. An apparatus according to claim 5, wherein the second belt is in the form a cylinder which has a main axis and which is, rotatable about said main axis of said cylinder.

7. An apparatus according to claim 4, wherein the depth of the cuttings on the second belt is controlled by a second depth gate.

8. An apparatus according to claim 1, wherein the mesh size of said belt is greater than 5μ.

9. An apparatus according to claim 4, wherein the mesh size of the second belt is smaller than that of the first belt.

10. An apparatus according to claim 4, wherein an air flow sensor is included to determine the air flow across at least one of said belts.

11. An apparatus according to claim 10, wherein the air flow sensor is coupled by means of a control unit, to the belt speed and the bed depth gate.

12. An apparatus according to claim 1, wherein a pressure sensor is included to determine the pressure to which the cuttings are being subjected.

13. An apparatus according to claim 12, wherein the pressure sensor is coupled, by means of a control unit, to the belt speed and the bed depth gate.

14. An apparatus according to claim 1, wherein the temperature of the heated air is maintained at 120-140° C.

15. An apparatus according to claim 1, wherein the reduced pressure to which the cuttings are subjected is from 18-35 (38-89 cm) inches of water.

16. An apparatus according to claim 1, wherein a heat exchanger is included, intermediate the cuttings and a condenser to remove excess heat from the contaminant-laden air stream.

17. An apparatus according to claim 1, including cleaning means to clean the or each belt.

18. An apparatus according to claim 17, wherein the cleaning means is a member selected from the group consisting of at least one brush having a rotating action, at least one brush having a linear brushing action, and a gas jet.

19. An apparatus according to claim 17, wherein at least two cleaning means are used disposed on opposite sides of the belt.

20. An apparatus according to claim 1, including a nozzle to emit a gas jet and agitate the drill cuttings on a belt, thereby allowing a greater proportion of cuttings surfaced to be exposed and hinder the buildup of compacted regions on the belt.

21. (canceled)
